(19) United States
(12) Patent Application Publication
(10) Pub. No.: US 2020/0165273 A1
(43) Pub. Date: May 28, 2020

(54) FLUORINATED ETHER COMPOUND, FLUORINATED ETHER COMPOSITION, COATING LIQUID, ARTICLE AND ITS PRODUCTION METHOD

(71) Applicant: AGC Inc., Chiyoda-ku (JP)

(72) Inventors: Taiki HOSHINO, Chiyoda-ku (JP); Eisuke MUROTANI, Chiyoda-ku (JP); Keigo MATSUURA, Chiyoda-ku (JP); Makoto UNO, Chiyoda-ku (JP)

(73) Assignee: AGC Inc., Chiyoda-ku (JP)

(21) Appl. No.: 16/776,559

(22) Filed: Jan. 30, 2020

Related U.S. Application Data
(63) Continuation of application No. PCT/JP2018/030221, filed on Aug. 13, 2018.

(30) Foreign Application Priority Data
Aug. 22, 2017 (JP) 2017-159697

(51) Int. Cl. C07F 7/08; C09D 183/12; C09D 5/00; C10M 107/50

(52) U.S. Cl. CPC C07F 7/081; C09D 183/12; C10N 2250/08; C10M 107/50; C10M 2229/0535; C09D 5/00

(57) ABSTRACT

To provide a fluorinated ether compound, a fluorinated ether composition and a coating liquid capable of forming a surface layer excellent in initial water/oil repellency, fingerprint stain removability, abrasion resistance, light resistance and chemical resistance, an article having a surface layer, and a method for producing it.

A fluorinated ether compound represented by A-O—(R^{f1}O)ₘ—R^{f2}—SO₂N(R¹)(R²), wherein A is a C₁₋₂₀ perfluoroalkyl group, R^{f1} is a fluoroalkylene group, m is an integer of from 2 to 500, R^{f2} is a fluoroalkylene group, R¹ is a monovalent organic group having at least one hydrolyzable silyl group, R² is a hydrogen atom, a monovalent organic group or a monovalent organic group having at least one hydrolyzable group, and the total number of the hydrolyzable silyl group(s) in R¹ and the hydrolyzable group(s) in R² is at least 2.

### TECHNICAL FIELD

The present invention relates to a fluorinated ether compound, a fluorinated ether composition, a coating liquid, an article and its production method.

### BACKGROUND ART

A fluorinated ether compound having a poly(oxyperfluoroalkylene) chain is capable of forming on a surface of a substrate a surface layer having high lubricity, water/oil repellency, etc. and thus is suitably used for a surface treatment agent. A surface treatment agent containing the fluorinated ether compound is used in an application where it is desired to maintain, for a long period of time, a performance (abrasion resistance) whereby water/oil repellency is less likely to be lowered even if the surface layer is rubbed repeatedly with fingers, and a performance (fingerprint stain removability) whereby a fingerprint adhering to the surface layer can be readily removed by wiping, for example, as a surface treatment agent for a member constituting a plane of a touch panel to be touched with fingers, a spectacle lens, a display of a wearable terminal, etc.

As a fluorinated ether compound which is capable of forming on a surface of a substrate a surface layer excellent in abrasion resistance and fingerprint stain removability, the following has been proposed.

A fluorinated ether compound which has a poly(oxyperfluoroalkylene) chain and two hydrolyzable silyl groups introduced to one terminal of the chain via a branch by a nitrogen atom (Patent Documents 1 and 2).

### PRIOR ART DOCUMENTS

### Patent Document

Patent Document 1: WO2017/038832

Patent Document 2: JP-A-2000-327772

### DISCLOSURE OF INVENTION

### Technical Problem

In recent years, a surface layer of e.g. a member constituting a surface to be touched with fingers of a touch panel is required to have further improved abrasion resistance, light resistance and chemical resistance. Accordingly, a fluorinated ether compound capable of forming a surface layer more excellent in abrasion resistance, light resistance and chemical resistance may sometimes be required.

An object of the present invention is to provide a fluorinated ether compound capable of forming a surface layer excellent in initial water/oil repellency, fingerprint stain removability, abrasion resistance, light resistance and chemical resistance; a fluorinated ether composition and a coating liquid containing the fluorinated ether compound; an article having a surface layer excellent in initial water/oil repellency, fingerprint stain removability, abrasion resistance, light resistance and chemical resistance, and a method for producing it.

Another object of the present invention is to provide a fluorinated ether compound useful as an intermediate of a fluorinated ether compound suitably used for a surface treatment agent.

### Solution to Problem

The present invention provides a fluorinated ether compound, a fluorinated ether composition, a coating liquid, an article, a method for producing an article, and a fluorinated ether compound according to another embodiment, having the following constructions [1] to [16].

[1] A fluorinated ether compound, which is a compound represented by the following formula 1:

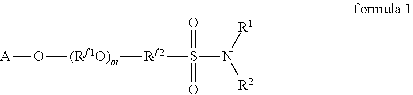

wherein A is a C₁₋₂₀ perfluoroalkyl group,

R^{f1} is a fluoroalkylene group,

m is an integer of from 2 to 500,

(R^{f1}O)ₘ may consist of two or more types of R^{f1}O differing in the number of carbon atoms,

R^{f2} is a fluoroalkylene group,

R¹ is a monovalent organic group having at least one hydrolyzable silyl group,

R² is a hydrogen atom, a monovalent organic group (excluding one having a hydrolyzable silyl group) or a monovalent organic group having at least one hydrolyzable silyl group, and

the total number of the hydrolyzable silyl group(s) in R¹ and the hydrolyzable silyl group(s) in R² is at least 2.

[2] The fluorinated ether compound according to [1], wherein the monovalent organic group having at least one hydrolyzable silyl group is a group represented by the following formula g1:

-Q¹[-SiR³ₙL₃₋ₙ]ₚ formula g1

wherein Q¹ is a (p+1) valent organic group (excluding one having a hydrolyzable silyl group),

R³ is a hydrogen atom or a monovalent hydrocarbon group,

L is a hydrolyzable group,

n is an integer of from 0 to 2,

p is an integer of at least 1, and

when p is at least 2, the p [—SiR³ₙL₃₋ₙ] may be the same or different.

[3] The fluorinated ether compound according to [2], wherein the group represented by the formula g1 is a group represented by the following formula g2 or g3:

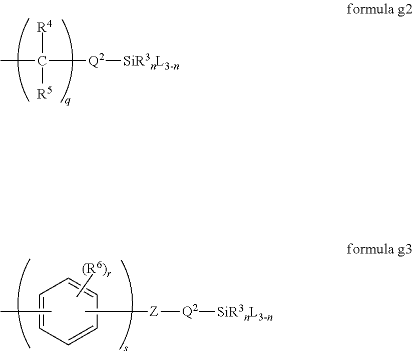

wherein R⁴ and R⁵ are each independently a hydrogen atom, a C₁₋₆ monovalent organic group (excluding one having a hydrolyzable silyl group) or -Q²-SiR³ₙL₃₋ₙ,

q is an integer of from 0 to 10,

when q is at least 2, the q (CR⁴R⁵) may be the same or different,

R⁶ is a C₁₋₆ monovalent organic group (excluding one having a hydrolyzable silyl group) or —Z-Q²-SiR³ₙL₃₋ₙ,

r is an integer of from 0 to 4,

when r is at least 2, the r R⁶ may be the same or different,

s is 1 or 2,

when s is 2, the two (φ(R⁶)ᵣ) (wherein φ is a benzene ring) may be the same or different,

Z is a single bond, —C(O)N(R⁷)— or —C(O)O—,

R⁷ is a hydrogen atom or an alkyl group,

Q² is a C₂₋₁₀ alkylene group,

R³ is a hydrogen atom or a monovalent hydrocarbon group,

L is a hydrolyzable group,

n is an integer of from 0 to 2, and

the plurality of -Q²-SiR³ₙL₃₋ₙ may be the same or different.

[4] The fluorinated ether compound according to [2] or [3], wherein both R¹ and R² are the group represented by the formula g1 wherein p is an integer of from 1 to 3.
[5] The fluorinated ether compound according to [2] or [3], wherein R¹ is the group represented by the formula g1 wherein p is 2 or 3, and

R² is a hydrogen atom or a monovalent organic group (excluding one having a hydrolyzable silyl group).

[6] A fluorinated ether composition comprising at least one type of the fluorinated ether compound as defined in any one of [1] to [5], and other fluorinated ether compound.
[7] A coating liquid comprising the fluorinated ether compound as defined in any one of [1] to [5] or the fluorinated ether composition as defined in [6], and a liquid medium.
[8] An article comprising a substrate and a surface layer formed of the fluorinated ether compound as defined in any one of [1] to [5] or the fluorinated ether composition as defined in [6] on a surface of the substrate.
[9] The article according to [8], which has the surface layer on a surface of a member constituting a plane to be touched with fingers of a touch panel.
[10] A method for producing an article, which comprises treating a surface of a substrate by dry coating method using the fluorinated ether compound as defined in any one of [1] to [5] or the fluorinated ether composition as defined in [6] to form a surface layer formed of the fluorinated ether compound or the fluorinated ether composition on the surface of the substrate.
[11] A method for producing an article, which comprises applying the coating liquid as defined in [7] to a surface of a substrate by wet coating method, followed by drying to form a surface layer formed of the fluorinated ether compound or the fluorinated ether composition on the surface of the substrate.
[12] A fluorinated ether compound, which is a compound represented by the following formula 2:

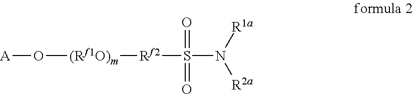

wherein A is a C₁₋₂₀ perfluoroalkyl group,

R^{f1} is a fluoroalkylene group,

m is an integer of from 2 to 500,

(R^{f1}O)ₘ may consist of two or more types of R^{f1}O differing in the number of carbon atoms,

R^{f2} is a fluoroalkylene group,

R^{1a} is a monovalent organic group having at least one ω-alkenyl group (excluding one having a hydrolyzable silyl group),

R^{2a} is a hydrogen atom, a monovalent organic group (excluding one having an ω-alkenyl group and one having a hydrolyzable silyl group) or a monovalent organic group having at least one ω-alkenyl group (excluding one having a hydrolyzable silyl group), and

the total number of the ω-alkenyl group(s) in R^{1a} and the ω-alkenyl group(s) in R^{2a} is at least 2.

[13] The fluorinated ether compound according to [12], wherein the monovalent organic group having at least one ω-alkenyl group is a group represented by the following formula g4:

-Q^{1a}[—CH═CH₂]ₚ formula g4

wherein Q^{1a} is a single bond (only when p is 1) or a (p+1) valent organic group (excluding one having a hydrolyzable silyl group), and

p is an integer of at least 1.

[14] The fluorinated ether compound according to [13], wherein the group represented by the formula g4 is a group represented by the following formula g5 or g6:

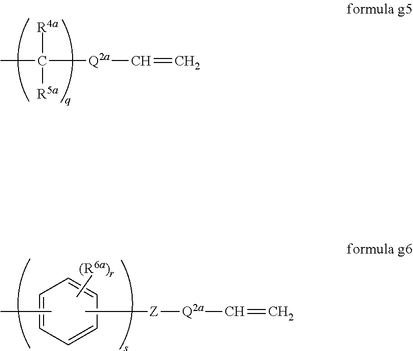

wherein R^{4a} and R^{5a} are each independently a hydrogen atom, a C₁₋₆ monovalent organic group (excluding one having a hydrolyzable silyl group) or -Q^{2a}-CH═CH₂,

q is an integer of from 0 to 10,

when q is at least 2, the q (CR^{4a}R^{5a}) may be the same or different,

R^{6a} is a C₁₋₆ monovalent organic group (excluding one having a hydrolyzable silyl group) or —Z-Q^{2a}-CH═CH₂,

r is an integer of from 0 to 4,

when r is at least 2, the r R^{6a} may be the same or different,

s is 1 or 2,

when s is 2, the two (φ(R^{6a})ᵣ) (wherein φ is a benzene ring) may be the same or different,

Z is a single bond, —C(O)N(R⁷)— or —C(O)O—,

R⁷ is a hydrogen atom or an alkyl group,

Q^{2a} is a single bond or a C₁₋₈ alkylene group, and

the plurality of Q^{2a} may be the same or different.

[15] The fluorinated ether compound according to [13] or [14], wherein both R^{1a} and R^{2a} are the group represented by the formula g4 wherein p is an integer of from 1 to 3.
[16] The fluorinated ether compound according to [13] or [14], wherein R^{1a} is the group represented by the formula g4 wherein p is 2 or 3, and R^{2a} is a hydrogen atom or a monovalent organic group (excluding one having an ω-alkenyl group and one having a hydrolyzable silyl group).

### Advantageous Effects of Invention

By the fluorinated ether compound of the present invention, it is possible to form a surface layer excellent in initial water/oil repellency, fingerprint stain removability, abrasion resistance, light resistance and chemical resistance.

By the fluorinated ether composition of the present invention, it is possible to form a surface layer excellent in initial water/oil repellency, fingerprint stain removability, abrasion resistance, light resistance and chemical resistance.

By the coating liquid of the present invention, it is possible to form a surface layer excellent in initial water/oil repellency, fingerprint stain removability, abrasion resistance, light resistance and chemical resistance.

The article of the present invention has a surface layer excellent in initial water/oil repellency, fingerprint stain removability, abrasion resistance, light resistance and chemical resistance.

According to the method for producing an article of the present invention, it is possible to produce an article having a surface layer excellent in initial water/oil repellency, fingerprint stain removability, abrasion resistance, light resistance and chemical resistance.

According to another embodiment, the fluorinated ether compound of the present invention is useful as an intermediate of the fluorinated ether compound suitably used for a surface treatment agent.

### DESCRIPTION OF EMBODIMENTS

In this specification, a compound represented by the formula 1 will be referred to as compound 1. Compounds represented by other formulae will be referred to in the same manner.

Further, a group represented by the formula g1 will be referred to as group g1. Groups represented by other formulae will be referred to in the same manner.

In this specification, meanings of the following terms are as follows.

The chemical formula of the oxyfluoroalkylene unit is represented so that its oxygen atom is described on the right-side of the fluoroalkylene group.

A “hydrolyzable silyl group” means a group capable of forming a silanol group (Si—OH) by being hydrolyzed, and is SiR³ₙL₃₋ₙ in the formula 1.

A “surface layer” means a layer formed on the surface of a substrate.

The “number average molecular weight” of the fluorinated ether compound is calculated by obtaining the number (average value) of oxyperfluoroalkylene units on the basis of terminal group, by ¹H-NMR and ¹⁹F-NMR. The terminal group may, for example, be A or a hydrolyzable silyl group in the formula 1.

### [Fluorinated Ether Compound]

The fluorinated ether compound of the present invention is compound 1.

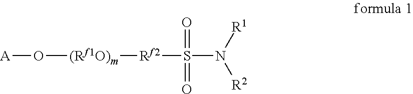

wherein A is a C₁₋₂₀ perfluoroalkyl group, R^{f1} is a fluoroalkylene group, m is an integer of from 2 to 500, (R^{f1}O)ₘ may consist of two or more types of R^{f1}O differing in the number of carbon atoms, R^{f2} is a fluoroalkylene group, R¹ is a monovalent organic group having at least one hydrolyzable silyl group, R² is a hydrogen atom, a monovalent organic group (excluding one having a hydrolyzable silyl group) or a monovalent organic group having at least one hydrolyzable silyl group, and the total number of the hydrolyzable silyl group(s) in R¹ and the hydrolyzable group(s) in R² is at least 2.

The number of carbon atoms in A is preferably from 1 to 10, more preferably from 1 to 6, particularly preferably from 1 to 3, whereby the surface layer formed of the compound 1 will be more excellent in lubricity and abrasion resistance.

The number of carbon atoms in R^{f1} is preferably from 1 to 6, in view of more excellent abrasion resistance and fingerprint stain removability of the surface layer.

R^{f1} is preferably a linear fluoroalkylene group in view of more excellent abrasion resistance and lubricity of the surface layer.

R^{f1} is preferably a perfluoroalkylene group in view of more excellent abrasion resistance and lubricity of the surface layer. R^{f1} other than the perfluoroalkylene group is preferably a C₂₋₆ polyfluoroalkylene group having from 1 to 4 hydrogen atoms and at least two fluorine atoms, more preferably a C₂₋₆ polyfluoroalkylene group having one or two hydrogen atoms and at least two fluorine atoms.

The proportion of the perfluoroalkylene group to the entire R^{f1} is preferably at least 60 mol %, more preferably at least 80 mol %, particularly preferably 100 mol %, in view of more excellent abrasion resistance and lubricity of the surface layer.

m is preferably from 2 to 200, more preferably an integer of from 5 to 150, particularly preferably an integer of from 10 to 100. When m is at least the lower limit value of the above range, the surface layer will be more excellent in water/oil repellency. When m is at most the upper limit value of the above range, the surface layer will be more excellent in abrasion resistance. That is, if the number average molecular weight of the compound 1 is too high, the number of hydrolyzable silyl groups present per unit molecular weight decreases, and the abrasion resistance of the surface layer will be lowered.

In (R^{f1}O)ₘ, when at least two types of R^{f1}O are present, the bonding order of the respective R^{f1}O is not limited. For example, when CF₂O and CF₂CF₂O are present, such CF₂O and CF₂CF₂O may be arranged randomly, alternately or in block.

At least two types of R^{f1}O being present is meant that at least two types of R^{f1}O differing in the number of carbon atoms are present, at least two types of R^{f1}O differing in the number of hydrogen atoms are present, at least two types of R^{f11}O differing in the positions of hydrogen atoms are present, and at least two types of R^{f11}O differing in whether side chains are present or not or in the type of side chains (e.g. the number of side chains, the number of carbon atoms in the side chain) even having the same number of carbon atoms, are present.

With respect to arrangement of at least two types of R^{f1}O, for example, a structure represented by {(CF₂O)ₘ₁(CF₂CF₂O)ₘ₂} indicates that m1 pieces of (CF₂O) and m2 pieces of (CF₂CF₂O) are randomly arranged. Further, a structure represented by (CF₂CF₂O—CF₂CF₂CF₂CF₂O)ₘ₅ indicates that m5 pieces of (CF₂CF₂O) and m5 pieces of (CF₂CF₂CF₂CF₂O) are alternately arranged.

As (R^{f1}O)ₘ, preferred is (R^{f1}O)ₘ having the following structure in at least a part thereof.
{(CF₂O)ₘ₁(CF₂CF₂O)ₘ₂}
(CF₂CF₂O)ₘ₃
(CF₂CF₂CF₂O)ₘ₄
(CF₂CF₂O—CF₂CF₂CF₂CF₂O)ₘ₅
(CF₂CF₂CF₂CF₂CF₂O)ₘ₆(CF₂O)ₘ₇
(CF₂CF₂CF₂CF₂CF₂O)ₘ₆(CF₂CF₂O)ₘ₇
(CF₂CF₂CF₂CF₂CF₂CF₂O)ₘ₆(CF₂O)ₘ₇
(CF₂CF₂CF₂CF₂CF₂CF₂O)ₘ₆(CF₂CF₂O)ₘ₇
(CF₂CF₂CF₂CF₂CF₂O—CF₂O)ₘ₈
(CF₂CF₂CF₂CF₂CF₂O—CF₂CF₂O)ₘ₈
(CF₂CF₂CF₂CF₂CF₂CF₂O—CF₂O)ₘ₈
(CF₂CF₂CF₂CF₂CF₂CF₂O—CF₂CF₂O)ₘ₈
(CF₂O—CF₂CF₂CF₂CF₂CF₂O)ₘ₈
(CF₂O—CF₂CF₂CF₂CF₂CF₂CF₂O)ₘ₈
(CF₂CF₂O—CF₂CF₂CF₂CF₂CF₂O)ₘ₈
(CF₂CF₂O—CF₂CF₂CF₂CF₂CF₂CF₂O)ₘ₈
   wherein m1 is an integer of at least 1, m2 is an integer of at least 1, m1+m2 is an integer of from 2 to 500, m3 and m4 are each an integer of from 2 to 500, m5 is an integer of from 1 to 250, m6 and m7 are each an integer of at least 1, m6+m7 is an integer of from 2 to 500, and m8 is an integer of from 1 to 250.

(R^{f1}O)ₘ is preferably as follows, in view of easy production of the compound 1.
{(CF₂O)ₘ₁(CF₂CF₂O)ₘ₂₋₃}CF₂CH₂O—CF₂CHFO—CF₂CF(CF₃)O
{(CF₂O)ₘ₁(CF₂CF₂O)ₘ₂₋₃}CF₂CF₂O—CF₂CF₂O—CF₂CF(CF₃)O
{(CF₂O)ₘ₁(CF₂CF₂O)ₘ₂₋₂}CF₂CH₂O—CF₂CHFCF₂O
{(CF₂O)ₘ₁(CF₂CF₂O)ₘ₂₋₂}CF₂CF₂O—CF₂CF₂CF₂O
{(CF₂O)ₘ (CF₂CF₂O)ₘ₂₋₂}CF₂CH₂O—CF₂CHFO
{(CF₂O)ₘ₁(CF₂CF₂O)ₘ₂₋₂}CF₂CF₂O—CF₂CF₂O
(CF₂CF₂CF₂O)ₘ₄₋₃CF₂CF₂CH₂O—CF₂CHFO—CF₂CF(CF₃)O
(CF₂CF₂CF₂O)ₘ₄₋₃CF₂CF₂CF₂O—CF₂CF₂O—CF₂CF(CF₃)O
(CF₂CF₂CF₂O)ₘ₄₋₂CF₂CF₂CH₂O—CF₂CHFCF₂O
(CF₂CF₂CF₂O)ₘ₄₋₂CF₂CF₂CF₂O—CF₂CF₂CF₂O
(CF₂CF₂CF₂O)ₘ₄₋₂CF₂CF₂CH₂O—CF₂CHFO
(CF₂CF₂CF₂O)ₘ₄₋₂CF₂CF₂CF₂O—CF₂CF₂O
(CF₂CF₂O—CF₂CF₂CF₂CF₂O)ₘ₅₋₂CF₂CF₂O—CF₂CF₂CF₂CH₂O—CF₂CHFO—CF₂CF(CF₃)O
(CF₂CF₂O—CF₂CF₂CF₂CF₂O)ₘ₅₋₂CF₂CF₂O—CF₂CF₂CF₂CF₂O—CF₂CF₂O—CF₂CF(CF₃)O
(CF₂CF₂O—CF₂CF₂CF₂CF₂O)ₘ₅₋₂CF₂CF₂O—CF₂CF₂CF₂CH₂O—CF₂CHFCF₂O
(CF₂CF₂O—CF₂CF₂CF₂CF₂O)ₘ₅₋₂CF₂CF₂O—CF₂CF₂CF₂CF₂O—CF₂CF₂CF₂O
(CF₂CF₂O—CF₂CF₂CF₂CF₂O)ₘ₅₋₂CF₂CF₂O—CF₂CF₂CF₂CH₂O—CF₂CHFO
(CF₂CF₂O—CF₂CF₂CF₂CF₂O)ₘ₅₋₂CF₂CF₂O—CF₂CF₂CF₂CF₂O—CF₂CF₂O
   wherein m2, m4 and m5 are selected so that m2-3, m2-2, m4-3, m4-2 and m5-2 are an integer of at least 1.

The number of carbon atoms in R^{f2} is preferably from 1 to 8, more preferably from 1 to 6, particularly preferably from 1 to 4, in view of more excellent abrasion resistance and fingerprint stain removability of the surface layer.

R^{f2} is preferably a perfluoroalkylene group, in view of more excellent abrasion resistance and lubricity of the surface layer.

The structure of R^{f2} depends on the raw material and the method for preparing the compound 1. R^{f2} is preferably —CF₂CF₂— in view of availability of the raw material.

The total number of the hydrolyzable silyl group(s) in R¹ and the hydrolyzable silyl group(s) in R² is preferably from 2 to 6, more preferably from 2 to 4, particularly preferably 2 or 3, whereby the compound 1 is easily produced and the resulting surface layer will be more excellent in abrasion resistance, light resistance and chemical resistance. When the number of hydrolyzable silyl groups is at least the lower limit value of the above range, the compound 1 will be firmly bonded to the surface of the substrate, whereby the surface layer will be more excellent in abrasion resistance, light resistance and chemical resistance. When the number of the hydrolyzable silyl groups is at most the upper limit value of the above range, the raw materials will be easily available, and the compound 1 is easily produced. Further, the terminal on the hydrolyzable silyl group side of the compound 1 will not be bulky, and the density of the compound 1 on the surface of the substrate is relatively high and as a result, the surface layer will be more excellent in abrasion resistance, light resistance and chemical resistance.

The number of carbon atoms in the monovalent organic group (excluding one having a hydrolyzable silyl group) as R² is preferably from 1 to 8, more preferably from 1 to 6, particularly preferably from 1 to 4.

In a case where R² is not a monovalent organic group having at least one hydrolyzable silyl group, R² is, in view of availability of raw materials, preferably a hydrogen atom or a C₁₋₄ alkyl group, particularly preferably a hydrogen atom or a methyl group.

The monovalent organic group having at least one hydrolyzable silyl group is preferably group g1, whereby the effects of the present invention are likely to be obtained.

-Q¹[-SiR³ₙL₃₋ₙ]ₚ formula g1

wherein Q¹ is a (p+1) valent organic group (excluding one having a hydrolyzable silyl group), R³ is a hydrogen atom or a monovalent hydrocarbon group, L is a hydrolyzable group, n is an integer of from 0 to 2, p is an integer of at least 1, and when p is at least 2, the p [—SiR³ₙL₃₋ₙ] may be the same or different.

p is preferably from 1 to 3, in that the compound 1 is easily produced and the resulting surface layer will be more excellent in abrasion resistance, light resistance and chemical resistance.

The organic group as Q¹ is, in view of more excellent light resistance and chemical resistance of the surface layer, preferably a saturated hydrocarbon group or an aromatic hydrocarbon group, or a group comprising a combination thereof. The number of carbon atoms in Q¹ is preferably from 2 to 20, particularly preferably from 2 to 12.

SiR³ₙL₃₋ₙ is a hydrolyzable silyl group.

The compound 1 has at least two hydrolyzable silyl groups at its terminal. The compound 1 having at least two hydrolyzable silyl groups at its terminal is firmly chemically bonded to a substrate, and is thereby capable of forming a surface layer excellent in abrasion resistance.

Further, the compound 1 has hydrolyzable silyl groups only at one terminal. The compound 1 having hydrolyzable silyl groups only at one terminal is less likely to aggregate, and is thereby capable of forming a surface layer excellent in outer appearance.

L is a hydrolyzable group. The hydrolyzable group is a group which becomes a hydroxy group by hydrolysis reaction. That is, Si-L at the terminal of the compound 1 becomes a silanol group (Si—OH) by hydrolysis reaction. Silanol groups will further be intermolecularly reacted to form Si—O—Si bonds. Further, a silanol group will undergo dehydration condensation reaction with a hydroxy group (substrate-OH) on the surface of a substrate, to form a chemical bond (substrate-O—Si).

L may, for example, be an alkoxy group, a halogen atom, an acyl group, an acyloxy group or an isocyanate group. The alkoxy group is preferably a C₁₋₄ alkoxy group. The halogen atom is preferably a chlorine atom.

L is, in view of easy production of the compound 1, preferably an alkoxy group or a halogen atom. L is, since outgassing during application will be less, and storage stability of the compound 1 will be excellent, preferably a C₁₋₄ alkoxy group, and in a case where long term storage stability of the compound 1 for a long time is required, particularly preferably an ethoxy group, and in a case where the reaction time after coating should be short, particularly preferably a methoxy group.

R³ is a hydrogen atom or a monovalent hydrocarbon group. The monovalent hydrocarbon group may, for example, be an alkyl group, a cycloalkyl group, an alkenyl group or an aryl group.

R³ is preferably a monovalent hydrocarbon group, particularly preferably a monovalent saturated hydrocarbon group. The number of carbon atoms in the monovalent saturated hydrocarbon group is preferably from 1 to 6, more preferably from 1 to 3, particularly preferably from 1 to 2. When the number of carbon atoms in R³ is within such a range, the compound 1 is likely to be produced.

n is preferably 0 or 1, particularly preferably 0. By the presence of a plurality of L in one hydrolyzable silyl group, bonding to the substrate will be more firm.

SIR³ₙL₃₋ₙ is preferably Si(OCH₃)₃, SiCH₃(OCH₃)₂, Si(OCH₂CH₃)₃, SiCl₃, Si(OCOCH₃)₃ or Si(NCO)₃. In view of handling efficiency in industrial production, Si(OCH₃)₃ is particularly preferred.

The at least two SiR³ₙL₃₋ₙ in the compound 1 may be the same or different. From the production efficiency of the compound 1, they are preferably the same group.

The group g1 is preferably group g2 or group g3, in that the compound 1 is easily produced and the resulting surface layer will be more excellent in abrasion resistance, light resistance and chemical resistance.

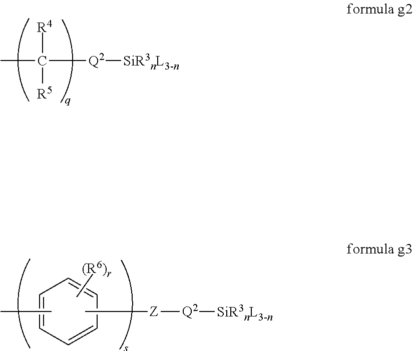

In the formulae, R⁴ and R⁵ are each independently a hydrogen atom, a C₁₋₆ monovalent organic group (excluding one having a hydrolyzable silyl group) or -Q²-SiR³ₙL₃₋ₙ, q is an integer of from 0 to 10, when q is at least 2, the q (CR⁴R⁵) may be the same or different, R⁶ is a C₁₋₆ monovalent organic group (excluding one having a hydrolyzable silyl group) or —Z-Q²-SiR³ₙL₃₋ₙ, r is an integer of from 0 to 4, when r is at least 2, the r R⁶ may be the same or different, s is 1 or 2, when s is 2, the two (φ(R⁶)ᵣ) (wherein φ is a benzene ring) may be the same or different, Z is a single bond, —C(O)N(R⁷)— or —C(O)O—, R⁷ is a hydrogen atom or an alkyl group, Q² is a C₂₋₁₀ alkylene group, R³ is a hydrogen atom or a monovalent hydrocarbon group, L is a hydrolyzable group, n is an integer of from 0 to 2, and the plurality of -Q²-SiR³ₙL₃₋ₙ may be the same or different.

The monovalent organic group as each of R⁴ and R⁵ is particularly preferably a C₁₋₄ monovalent organic group.

In a case where R⁴ and R⁵ are not -Q²-SiR³ₙL₃₋ₙ, they are each independently preferably a hydrogen atom or a C₁₋₄ alkyl group in view of availability of the raw material, particularly preferably a hydrogen atom or a methyl group.

q is preferably an integer of from 0 to 2, in that the compound 1 is easily produced and the resulting surface layer will be more excellent in abrasion resistance, light resistance and chemical resistance.

The monovalent organic group as R⁶ is particularly preferably a C₁₋₄ monovalent organic group.

In a case where R⁶ is not —Z-Q²-SiR³ₙL₃₋ₙ, R⁶ is preferably a C₁₋₄ alkyl group, particularly preferably a methyl group, in view of availability of raw material.

r is preferably an integer of from 0 to 2, more preferably 0 or 1, particularly preferably 0, in that the compound 1 is easily produced and the resulting surface layer will be more excellent in abrasion resistance, light resistance and chemical resistance.

s is preferably 1, in that the compound 1 is easily produced and the resulting surface layer will be more excellent in abrasion resistance, light resistance and chemical resistance.

Z is preferably a single bond, in that the resulting surface layer will be more excellent in abrasion resistance, light resistance and chemical resistance.

R⁷ is preferably a hydrogen atom in that the compound 1 is easily produced. The number of carbon atoms in the alkyl group as R⁷ is preferably from 1 to 3, particularly preferably 1.

The number of carbon atoms in Q² is preferably from 2 to 6, particularly preferably from 2 to 4.

As the group g2, for example, the following groups may be mentioned. In the formulae, * represents a connecting bond.

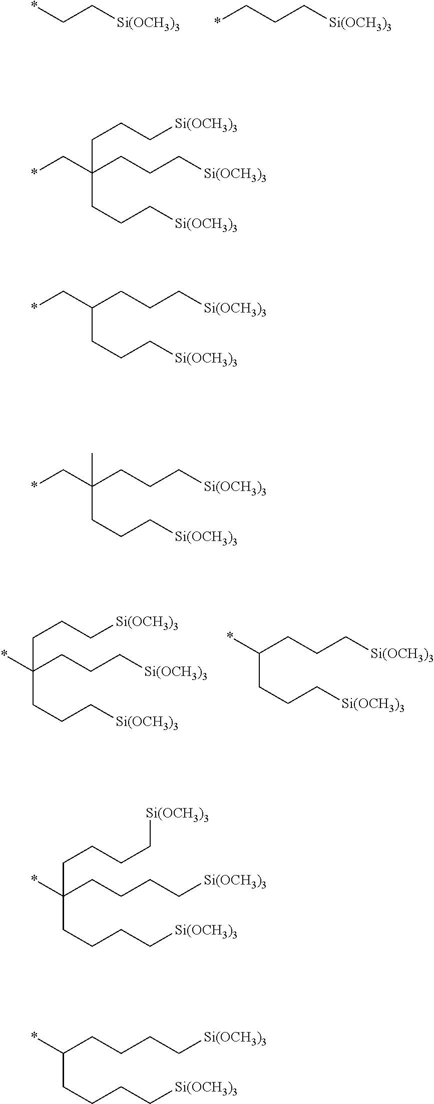

As the group g3, for example, the following groups may be mentioned. In the formulae, * represents a connecting bond.

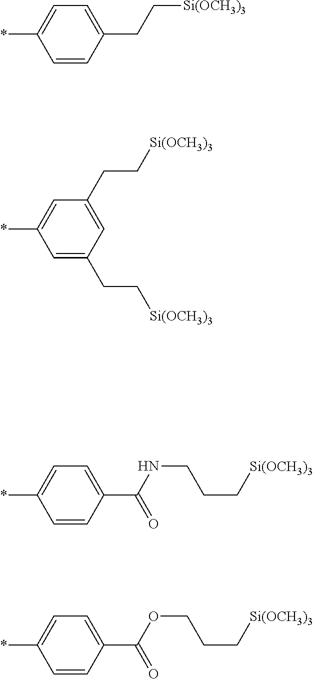

As the combination of R¹ and R², the following combination is preferred in that the surface layer will be more excellent in abrasion resistance, light resistance and chemical resistance.
Both R¹ and R² are the group g1 wherein p is an integer of from 1 to 3.
R¹ is the group g1 wherein p is 2 or 3, and R² is a hydrogen atom or a monovalent organic group (excluding one having a hydrolyzable silyl group).

As the compound 1, for example, compounds of the following formulae may be mentioned. The following compounds are preferred from such a viewpoint that they are industrially easy to manufacture and easy to handle, and they provide a surface layer further excellent in water/oil repellency, abrasion resistance, fingerprint stain removability, lubricity, chemical resistance, light resistance and chemical resistance.

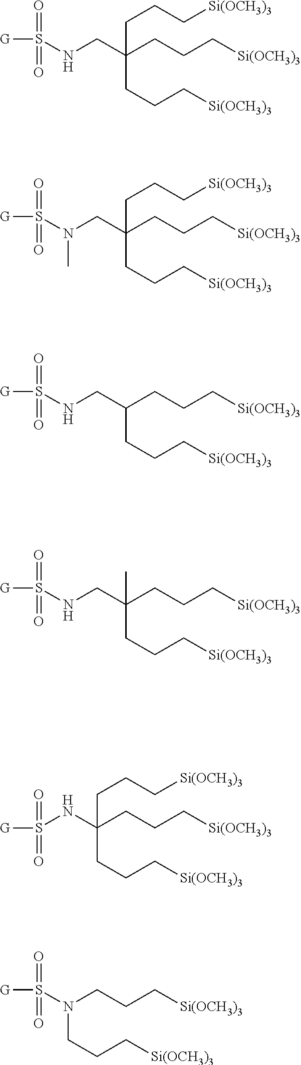

In the formulae, G is a polyfluoropolyether chain, that is, A-O—(R^{f1}O)ₘ— R^{f2}—. A preferred embodiment of G is the combination of the above preferred A, (R^{f1}O)ₘ and R^{f2}.

### (Method for Producing Compound 1)

The compound 1 may be produced by a method of subjecting compound 2 and HSiR³ₙL₃₋ₙ to hydrosilylation.

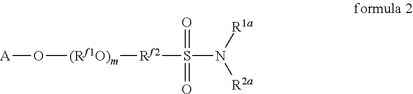

wherein R^{1a} is a monovalent organic group having at least one ω-alkenyl group (excluding one having a hydrolyzable silyl group), R^{2a} is a hydrogen atom, a monovalent organic group (excluding one having an ω-alkenyl group and one having a hydrolyzable silyl group) or a monovalent organic group having at least one ω-alkenyl group (excluding one having a hydrolyzable silyl group), and the total number of the ω-alkenyl group(s) in R^{1a} and the ω-alkenyl group(s) in R^{2a} is at least 2. R^{1a} and R^{2a} become R¹ and R² in the compound 1 after hydrosilylation.

A, (R^{f1}O)ₘ and R^{f2} are the same as A, (R^{f1}O)ₘ and R^{f2} as described for the compound 1, and the preferred embodiments are also the same.

The total number of the ω-alkenyl group(s) in R^{1a} and the ω-alkenyl group(s) in R^{2a} is preferably from 2 to 6, more preferably from 2 to 4, particularly preferably 2 or 3, in that the compound 1 is easily produced and the resulting surface layer will be more excellent in abrasion resistance, light resistance and chemical resistance. When the number of the ω-alkenyl groups is at least the lower limit value of the above range, the compound 1 obtainable from the compound 2 will be firmly bonded to the surface of the substrate, and the resulting surface layer will be more excellent in abrasion resistance, light resistance and chemical resistance. When the number of the ω-alkenyl groups is at most the upper limit value of the above range, raw material is easily available and the compound 2 is easily produced. Further, the terminal at the hydrolyzable silyl group side of the compound 1 obtainable from the compound 2 will not be bulky, and the density of the compound 1 on the surface of the substrate will be relatively high. As a result, the surface layer will be more excellent in abrasion resistance, light resistance and chemical resistance.

The monovalent organic group having at least one ω-alkenyl group is preferably group g4 in that a preferred compound 1 is obtained.

-Q^{1a}[-CH═CH₂]ₚ formula g4

wherein Q^{1a} is a single bond (only when p is 1) or a (p+1) valent organic group (excluding one having a hydrolyzable silyl group). The group g4 becomes Q¹ in the group g1 after hydrosilylation.

p is the same as p as described for the group g1, and the preferred embodiment is also the same.

The group g4 is preferably group g5 or group g6 in that a preferred compound 1 is obtained.

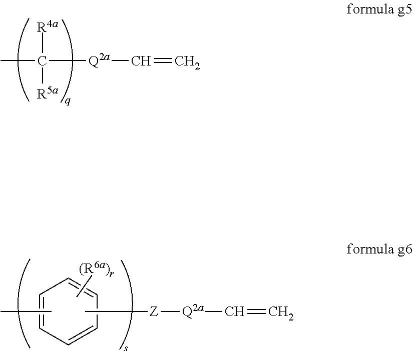

wherein R^{4a} and R^{5a} are each independently a hydrogen atom, a C₁₋₆ monovalent organic group (excluding one having a hydrolyzable silyl group) or -Q^{2a}-CH═CH₂, when q is at least 2, the q (CR^{4a}R^{5a}) may be the same or different, R^{6a} is a C₁₋₆ monovalent organic group (excluding one having a hydrolyzable silyl group) or —Z-Q^{2a}-CH═CH₂, when r is at least 2, the r R^{6a} may be the same or different, when s is 2, the two (φ(R^{6a})ᵣ) (wherein φ is a benzene ring) may be the same or different, Q^{2a} is a single bond or a C₁₋₈ alkylene group, and the plurality of Q^{2a} may be the same or different.

R^{4a}, R^{5a} and R^{6a} become R⁴, R⁵ and R⁶ in the group g2 or g3 after hydrosilylation. -Q^{2a}-CH═CH₂ becomes Q² in the group g2 or g3 after hydrosilylation.

q, r, s and Z are the same as q, r, s and Z as described for the group g2 or g3, and the preferred embodiments are also the same.

As a combination of R^{1a} and R^{2a}, the following combinations are preferred in that a preferred compound 1 is obtained.
Both R^{1a} and R^{2a} are the group g4 wherein p is an integer of from 1 to 3.
R^{1a} is the group g4 wherein p is 2 or 3, and R^{2a} is a hydrogen atom or a monovalent organic group (excluding one having an ω-alkenyl group and one having a hydrolyzable silyl group).

### (Method for Producing Compound 2)

Method i: The compound 2 may be produced, for example, as follows.

In the presence of an amine, compound 3 and compound to be a protective group for —SO₂F (for example, p-nitrophenol) are reacted to obtain compound 4.

CF₂═CF(CF₂)ₜO—(R^{f1}O)ᵤ—R^{f2}—SO₂F formula 3

CF₂═CF(CF₂)ₜO—(R^{f1}O)ᵤ—R^{f2}—SO₂—OPhNO₂ formula 4

In the formulae, Ph is a phenylene group, t is 0 or 1, u is an integer of from 0 to 5, and when u is at least 2, (R^{f1}O)ᵤ may consist of two or more types of R^{f1}O differing in the number of carbon atoms.

As the compound 3, in view of reactivity and availability, the following compounds are preferred.
CF₂═CFO—CF₂CF(CF₃)O—CF₂CF₂—SO₂F,
CF₂═CFCF₂O—CF₂CF₂—SO₂F,
CF₂═CFO—CF₂CF₂—SO₂F.

The compound 3 may be produced e.g. by the method disclosed in D. J. Vaugham, “Du Pont Inovation”, Vol. 43, No. 3, 1973, page 10 or the method disclosed in Examples of U.S. Pat. No. 4,358,412.

In the presence of a basic compound, the compound 4 and compound 5 are reacted to obtain compound 6.

A-O—(R^{f1}O)ₓ—R^{f11}CH₂OH formula 5

A-O—(R^{f1}O)ₓ—R^{f11}CH₂O—CF₂CHF(CF₂)ₜO—(R^{f1}O)ᵤ—R^{f2}—SO₂—OPhNO₂ formula 6

In the formulae, x is an integer of at least 1, and x+2+u is an integer of at most 500, R^{f11} is a C₁₋₅ perfluoroalkylene group, and when x is at least 2, (R^{f1}O)ₓ may consist of two or more types of R^{f1}O differing in the number of carbon atoms.

The compound 5 may be produced by the method disclosed in WO2009/008380, WO2013/121984, WO2013/121986, WO2015/087902, WO2017/038830, WO2017/038832 or the like.

The compound 6 and compound 7 are reacted to obtain compound 21.

HN(R^{1a})(R^{2a}) formula 7

A-O—(R^{f1}O)ₓ—R^{f11}CH₂O—CF₂CHF(CF₂)ₜO—(R^{f1}O)ᵤ—R^{f2}—SO₂N(R^{1a})(R^{2a}) formula 21

The formula 21 may be expressed by the formula 2 by summing up the oxyfluoroalkylene groups.

As the compound 7, for example, the following compounds may be mentioned.

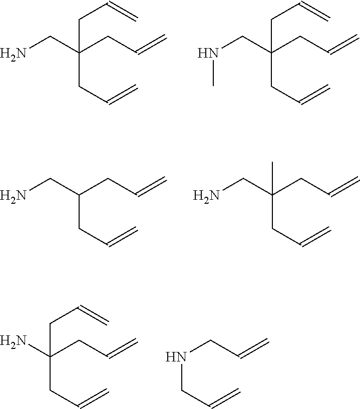

Method ii: The compound 2 wherein R^{f1} and R^{f2} are a perfluoroalkylene group may be produced, for example, as follows.

The compound 6 and KF are reacted to obtain compound 8.

A-O—(R^{f1}O)ₓ—R^{f11}CH₂O—CF₂CHF(CF₂)ₜO—(R^{f1}O)ᵤ—R^{f2}—SO₂F formula 8

The compound 8 is subjected to fluorination to obtain compound 9.

A-O—(R^{f1}O)ₓ—R^{f11}CF₂O—CF₂CF₂(CF₂)ₜO—(R^{f1}O)ᵤ—R^{f2}—SO₂F formula 9

wherein R^{f1}, R^{f11} and R^{f2} are a perfluoroalkylene group.

In the presence of an amine, the compound 9 and the compound 7 are reacted to obtain compound 22.

A-O—(R^{f1}O)ₓ—R^{f11}CF₂O—CF₂CF₂(CF₂)ₜO—(R^{f1}O)ᵤ—R^{f2}—SO₂N(R^{1a})(R^{2a}) formula 22

The formula 22 may be expressed by the formula 2 by summing up the oxyperfluoroalkylene groups.

Method iii: The compound 2 may be produced also by the following preparation route.

Compound 11 is obtained from the compound 3 in accordance with the method disclosed in Journal of Fluorine Chemistry, Vol. 125, 2004, page 1,231.

CF₂BrCFBr(CF₂)ₜO—(R^{f1}O)ᵤ—R^{f2}—SO₂F formula 11

The compound 11 and the compound 7 are reacted to obtain compound 12.

CF₂BrCFBr(CF₂)ₜO—(R^{f1}O)ᵤ—R^{f2}—SO₂N(R^{1a})(R^{2a}) formula 12

The compound 12 is subjected to debromination to obtain compound 13.

CF₂═CF(CF₂)ₜO—(R^{f1}O)ᵤ—R^{f2}—SO₂N(R^{1a})(R^{2a}) formula 13

In the presence of a basic compound, the compound 13 and the compound 5 are reacted to obtain the compound 21.

The above-described compound 1 is capable of forming a surface layer excellent in initial water/oil repellency, fingerprint stain removability, abrasion resistance, light resistance and chemical resistance, from the following reasons.

The compound 1, in which A has CF₃— at its terminal, has CF₃— at one terminal thereof, and has hydrolyzable silyl group at the other end. According to the compound 1 having CF₃— at one terminal and hydrolyzable silyl group at the other terminal, a surface layer having a low surface energy can be formed, which is excellent in lubricity and abrasion resistance. Whereas a surface layer formed of a fluorinated ether compound having a hydrolyzable silyl group at both terminals is insufficient in lubricity and abrasion resistance.

The compound 1 has (R^{f1}O)ₘ and thereby has a high fluorine atom content. Accordingly, the compound 1 is capable of forming a surface layer excellent in initial water/oil repellency, abrasion resistance and fingerprint stain removability.

The compound 1 has a plurality of hydrolyzable silyl groups introduced to one terminal of the polyfluoropolyether chain via a linking group having SO₂N, and accordingly the bond between the polyfluoropolyether chain and the hydrolyzable silyl group is hardly cleaved e.g. by friction, light and chemicals. Accordingly, the compound 1 is capable of forming a surface layer excellent in abrasion resistance, light resistance and chemical resistance.

### [Fluorinated Ether Composition]

The fluorinated ether composition of the present invention (hereinafter sometimes referred to as “the present composition”) comprises at least one type of the compound 1 and other fluorinated ether compound.

As other fluorinated ether compound, a fluorinated ether compound formed as a by-product during production of the compound 1 (hereinafter sometimes referred to as “by-product fluorinated ether compound”) and a known fluorinated ether compound used in the same applications as the compound 1 may, for example, be mentioned.

Other fluorinated ether compound is preferably one unlikely to impair the properties of the compound 1.

As the by-product fluorinated ether compound, unreacted compounds 2 and 5 to 8, and fluorinated ether compounds formed through isomerization of some of the allyl groups into an inner olefin accompanying hydrosilylation during the production of the compound 1 may, for example, be mentioned.

As the known fluorinated ether compound, a commercially available fluorinated ether compound may, for example, be mentioned. In a case where the present composition contains a known fluorinated ether compound, it may have new effects such as compensation for the properties of the compound 1.

The content of the compound 1 is preferably at least 60 mass % and less than 100 mass %, more preferably at least 70 mass % and less than 100 mass %, particularly preferably at least 80 mass % and less than 100 mass % in the present composition.

The content of other fluorinated ether compound is preferably more than 0 mass % and at most 40 mass %, more preferably more than 0 mass % and at most 30 mass %, particularly preferably more than 0 mass % and at most 20 mass % in the present composition.

The total content of the compound 1 and other fluorinated ether compound is preferably from 80 to 100 mass %, particularly preferably from 85 to 100 mass % in the present composition.

When the content of the compound 1 and the content of other fluorinated ether compound are within the above ranges, the surface layer will be more excellent in initial water/oil repellency, abrasion resistance, fingerprint stain removability, light resistance and chemical resistance.

The present composition may contain a component other than the compound 1 and other fluorinated ether compound within a range not to impair the effects of the present invention.

Other component may, for example, be a by-product formed during production of the compound 1 or the known fluorinated ether compound (excluding the by-product fluorinated ether compound) or a compound inevitable in production such as an unreacted raw material.

Further, additives such as an acid catalyst or a basic catalyst to promote hydrolysis and condensation reaction of the hydrolyzable silyl group may be mentioned. The acid catalyst may, for example, be hydrochloric acid, nitric acid, acetic acid, sulfuric acid, phosphoric acid, sulfonic acid, methanesulfonic acid or p-toluenesulfonic acid. The basic catalyst may, for example, be sodium hydroxide, potassium hydroxide or ammonia.

The content of other component is preferably from 0 to 10 mass %, particularly preferably from 0 to 1 mass % in the present composition.

### [Coating Liquid]

The coating liquid of the present invention (hereinafter sometimes referred to as “the present coating liquid”) comprises the compound 1 or the present composition, and a liquid medium. The present coating liquid may be a solution or a dispersion.

The liquid medium is preferably an organic solvent. The organic solvent may be a fluorinated organic solvent, may be a non-fluorinated organic solvent, or may contain both solvents.

The fluorinated organic solvent may, for example, be a fluorinated alkane, a fluorinated aromatic compound, a fluoroalkyl ether, a fluorinated alkylamine, a fluoroalcohol, etc.

The fluorinated alkane is preferably a C₄₋₈ compound. Commercially available products may, for example, be C₆F₁₃H (manufactured by Asahi Glass Company, Limited, ASAHIKLIN (registered trademark) AC-2000), C₆F₁₃C₂H₅ (manufactured by Asahi Glass Company, Limited, ASAHIKLIN (registered trademark) AC-6000), and C₂F₅CHFCHFCF₃ (manufactured by Chemours, Vertrel (registered trademark) XF).

The fluorinated aromatic compound may, for example, be hexafluorobenzene, trifluoromethylbenzene, perfluorotoluene or bis(trifluoromethyl)benzene.

The fluoroalkyl ether is preferably a C₄₋₁₂ compound. Commercially available products may, for example, be CF₃CH₂OCF₂CF₂H (manufactured by Asahi Glass Company, Limited, ASAHIKLIN (registered trademark) AE-3000), C₄F₉OCH₃ (manufactured by 3M, Novec (registered trademark) 7100), C₄F₉OC₂H₅ (manufactured by 3M, Novec (registered trademark) 7200), and C₂F₅CF(OCH₃)C₃F₇ (manufactured by 3M, Novec (registered trademark) 7300).

The fluorinated alkylamine may, for example, be perfluorotripropylamine or perfluorotributylamine,

The fluoroalcohol may, for example, be 2,2,3,3-tetrafluoropropanol, 2,2,2-trifluoroethanol or hexafluoroisopropanol.

The non-fluorinated organic solvent is preferably a compound consisting solely of hydrogen atoms and carbon atoms, or a compound consisting solely of hydrogen atoms, carbon atoms and oxygen atoms, and may be a hydrocarbon, an alcohol, a ketone, an ether, or an ester.

The liquid medium may be a mixed medium having two or more types mixed.

The content of the compound 1 or the present composition is preferably from 0.001 to 10 mass %, particularly preferably from 0.01 to 1 mass % in the present coating liquid.

The content of the liquid medium is preferably from 90 to 99.999 mass %, particularly preferably from 99 to 99.99 mass % in the present coating liquid.

### [Article]

The article of the present invention (hereinafter sometimes referred to as “the present article”) has a surface layer formed of the compound 1 or the present composition on the surface of a substrate.

The surface layer contains the compound 1 in a state where some or all of hydrolyzable silyl groups in the compound 1 are hydrolyzed and subjected to dehydration condensation reaction.

The thickness of the surface layer is preferably from 1 to 100 nm, particularly preferably from 1 to 50 nm. When the thickness of the surface layer is at least the lower limit value of the above range, the effect by the surface treatment is likely to be sufficiently obtained. When the thickness of the surface layer is at most the upper limit value of the above range, utilization efficiency will be high. The thickness of the surface layer can be calculated from an oscillation period of an interference pattern of reflected X-ray, obtained by X-ray reflectance method using an X-ray diffractometer for thin film analysis (manufactured by Rigaku Corporation, ATX-G).

The substrate may be a substrate which is desired to have water/oil repellency imparted. The material of the substrate may, for example, be a metal, a resin, glass, sapphire, ceramic, stone or a composite material thereof. The glass may be chemically tempered. The substrate may have a primer film such as a SiO₂ film formed on its surface.

As the substrate, a substrate for a touch panel, a substrate for display or a spectacle lens is preferred, and a substrate for a touch panel is particularly preferred. As the material of a substrate for a touch panel, glass or a transparent resin is preferred.

### [Method for Producing Article]

The present article may be produced, for example, by the following method.
A method of treating the surface of a substrate by dry coating method using the compound 1 or the present composition, to form a surface layer formed of the compound 1 or the present composition on the surface of the substrate.
A method of applying the present coating liquid to the surface of a substrate by wet coating method, followed by drying to form a surface layer formed of the compound 1 or the present composition on the surface of the substrate.

As the dry coating method, a method such as vacuum deposition, CVD or sputtering may be mentioned. With a view to suppressing decomposition of the compound 1 and from the viewpoint of simplicity of apparatus, vacuum deposition method is preferred. At the time of vacuum deposition, a pelletized material having a metal porous product of iron, steel of the like impregnated with the compound 1 or the present composition may be used. A pelletized material impregnated with the compound 1 or the present composition, obtained by impregnating a metal porous product of iron, steel of the like with the present coating liquid and drying the liquid medium, may be used.

The wet coating method may, for example, be a spin coating method, a wipe coating method, a spray coating method, a squeegee coating method, a dip coating method, a die coating method, an ink-jet method, a flow coating method, a roll coating method, a casting method, a Langmuir-Blodgett method, or a gravure coating method.

### EXAMPLES

Now, the present invention will be described in further detail with reference to Examples, but the present invention is not limited to these Examples. Hereinafter, “%” is “mass %” unless otherwise specified. Ex. 1 to 5 and 8 to 11 are Examples of the present invention, and Ex. 6, 7, 12 and 13 are Comparative Examples.

### Ex. 1

### Ex. 1-1

Into a 1,000 mL eggplant flask, 16.4 g of p-nitrophenol, 16.2 g of triethylamine, 0.066 g of dimethylaminopyridine, and 300 mL of dichloropentafluoropropane (manufactured by Asahi Glass Company, Limited, AK-225) were put, followed by stirring under cooling with ice. Then, 50 g of the compound 3-1 as disclosed in Examples of WO2011/013577 was slowly added, followed by stirring at 25° C. for 5 hours. 16.2 g of triethylamine was further added, followed by stirring for 15 hours. The solvent was distilled off, and the residue was purified by silica gel column chromatography to obtain 39 g (yield: 65%) of compound 4-1.

CF₂═CFO—CF₂CF(CF₃)O—CF₂CF₂—SO₂F formula 3-1

CF₂═CFO—CF₂CF(CF₃)O—CF₂CF₂—SO₂—OPhNO₂ formula 4-1

NMR spectrum of compound 4-1:

¹H-NMR (300.4 MHz, solvent: CDCl₃, reference: tetramethoxysilane (TMS)) δ(ppm): 7.5 (2H), 8.4 (2H).

¹⁹F-NMR (282.7 MHz, solvent: CDCl₃, reference: CFCl₃) δ(ppm): −78 (2F), −79 (3F), −84 (2F), −112 (3F), −121 (1F), −134 (1F), −144 (1F).

### Ex. 1-2

Compound 5-1 was obtained in accordance with the method disclosed in Ex. 3 in WO2017/038832.

CF₃—O—(CF₂CF₂O—CF₂CF₂CF₂CF₂O)ₓ₃CF₂CF₂O—CF₂CF₂CF₂CH₂OH formula 5-1

Mean value of unit number x3: 12, number average molecular weight of compound 5-1: 3,800.

### Ex. 1-3

Into a 500 mL eggplant flask, 100 g of the compound 5-1 obtained in Ex. 1-2, 15.0 g of the compound 4-1 obtained in Ex. 1-1, 11.7 g of 2-methyl-2-propanol, 3.4 g of a 48 mass % potassium hydroxide aqueous solution and 3.4 g of water were put, followed by stirring at 70° C. for 20 hours. The mixture was cooled to 25° C., methanol was put, followed by sufficient stirring, and AC-6000 was put, followed by sufficient stirring. The AC-6000 layer was recovered, the solvent was distilled off, and the residue was purified by silica gel column chromatography to obtain 8.44 g (yield: 7.4%) of compound 6-1.

CF₃—O—(CF₂CF₂O—CF₂CF₂CF₂CF₂O)ₓ₃CF₂CF₂O—CF₂CF₂CF₂CH₂O—CF₂CHFO—CF₂CF(CF₃)O—CF₂CF₂—SO₂—OPhNO₂ formula 6-1

NMR spectrum of compound 6-1:

¹H-NMR (300.4 MHz, solvent: CDCl₃, reference: TMS) δ(ppm): 7.5 (2H), 8.4 (2H), 6.0 (1H), 4.5 (2H).

¹⁹F-NMR (282.7 MHz, solvent: CDCl₃, reference: CFCl₃) δ(ppm): −55 (3F), −78 (2F), −79 (3F), −83 (50F), −85 (1F), −88 (50F), −90 (4F), −112 (2F), −120 (2F), −125 (48F), −126 (2F), −144 (2F).

Mean value of unit number x3: 12.

### Ex. 1-4

Into a 100 mL eggplant flask, 5.0 g of the compound 6-1 obtained in Ex. 1-3, 6 mL of 1,3-di(trifluoromethyl)benzene and 0.37 g of compound 7-1 were put, followed by stirring overnight under reflux with heating. The mixture was cooled to 25° C., methanol was put, followed by sufficient stirring, and AC-6000 was put, followed by sufficient stirring. The AC-6000 layer was recovered, the solvent was distilled off, and the residue was purified by silica gel column chromatography to obtain 4.6 g (yield: 92%) of compound 2-1.

H₂N—CH₂—C[—CH₂—CH═CH₂]₃ formula 7-1

CF₃—O—(CF₂CF₂O—CF₂CF₂CF₂CF₂O)ₓ₃CF₂CF₂O—CF₂CF₂CF₂CH₂O—CF₂CHFO—CF₂CF(CF₃)O—CF₂CF₂—SO₂NH—CH₂—C[—CH₂—CH═CH₂]₃ formula 2-1

NMR spectrum of compound 2-1:

¹H-NMR (300.4 MHz, solvent: CDCl₃, reference: TMS) δ(ppm): 6.0 (4H), 5.0 (6H), 4.5 (2H), 2.6 (2H), 1.9 (6H).

¹⁹F-NMR (282.7 MHz, solvent: CDCl₃, reference: CFCl₃) δ(ppm): −55 (3F), −78 (2F), −79 (3F), −83 (50F), −85 (1F), −88 (50F), −90 (4F), −116 (2F), −120 (2F), −125 (48F), −126 (2F), −144 (2F).

Mean value of unit number x3: 12.

### Ex. 1-5

Into a 50 mL eggplant flask, 1.0 g of the compound 2-1 obtained in Ex. 1-4, 0.11 g of trimethoxysilane, 0.0011 g of aniline, 1.0 g of AC-6000, and 0.0033 g of a platinum/1,3-divinyl-1,1,3,3-tetramethyldisiloxane complex were put, followed by stirring at 25° C. overnight and then by concentration to obtain 1.0 g (yield: 100%) of compound 1-1.

CF₃—O—(CF₂CF₂O—CF₂CF₂CF₂CF₂O)ₓ₃CF₂CF₂O—CF₂CF₂CF₂CH₂O—CF₂CHFO—CF₂CF(CF₃)O—CF₂CF₂—SO₂NH—CH₂—C[—CH₂CH₂CH₂—Si(OCH₃)₃]₃ formula 1-1

NMR spectrum of compound 1-1:

¹H-NMR (300.4 MHz, solvent: CDCl₃, reference: TMS) δ(ppm): 6.0 (1H), 4.5 (2H), 4.0 (27H), 2.6 (2H), 1.3 (12H), 0.7 (6H).

¹⁹F-NMR (282.7 MHz, solvent: CDCl₃, reference: CFCl₃) δ(ppm): −55 (3F), −78 (2F), −79 (3F), −83 (50F), −85 (1F), −88 (50F), −90 (4F), −116 (2F), −120 (2F), −125 (48F), −126 (2F), −144 (2F).

Mean value of unit number x3: 12, number average molecular weight of compound 1-1: 4,700.

### Ex. 2

### Ex. 2-1

Compound 11-1 was obtained in accordance with the method as disclosed in Journal of Fluorine Chemistry, Vol. 125, 2004, page 1,231.

CF₂BrCFBrO—CF₂CF(CF₃)O—CF₂CF₂—SO₂F formula 11-1

### Ex. 2-2

Into a 100 mL eggplant flask, 10 g of the compound 11-1 obtained in Ex. 2-1, 13 g of pyridine and 3 g of the compound 7-1 used in Ex. 1-4 were put, followed by stirring at 100° C. for 20 hours. Water was added, followed by stirring for 10 minutes, and the mixture was separated into two layers with methylene chloride, the resulting organic layer was recovered, and the solvent was distilled off. The obtained crude liquid was purified by silica gel column chromatography to obtain 4.2 g (yield: 34%) of compound 12-1.

CF₂BrCFBrO—CF₂CF(CF₃)O—CF₂CF₂—SO₂NH—CH₂—C[CH₂CH═CH₂]₃ formula 12-1

NMR spectrum of compound 12-1:

¹H-NMR (300.4 MHz, solvent: CDCl₃, reference: TMS) δ(ppm): 6.0 (3H), 5.1 (6H), 3.2 (2H), 2.1 (6H).

¹⁹F-NMR (282.7 MHz, solvent: CDCl₃, reference: CFCl₃) δ(ppm): −70 (1F), −78 (5F), −81 (1F), −116 (2F), −145 (1F).

### Ex. 2-3

Into a 100 mL eggplant flask, 0.70 g of zinc powder, 4.28 g of the compound 12-1 obtained in Ex. 2-2 and 16 g of acetonitrile were put, followed by stirring at 60° C. for 2 hours. The solid was removed by filtration, and the solvent was distilled off to obtain 3.3 g (yield: 99%) of compound 13-1.

CF₂═CFO—CF₂CF(CF₃)O—CF₂CF₂—SO₂NH—CH₂—C[CH₂CH═CH₂]₃ formula 13-1

NMR spectrum of compound 13-1:

¹H-NMR (300.4 MHz, solvent: CDCl₃, reference: TMS) δ(ppm): 6.0 (3H), 5.1 (6H), 3.2 (2H), 2.1 (6H).

¹⁹F-NMR (282.7 MHz, solvent: CDCl₃, reference: CFCl₃) δ(ppm): −78 (2F), −79 (3F), −84 (2F), −113 (1F), −116 (2F), −122 (1F), −135 (1F), −145 (1F)

### Ex. 2-4

Into a 50 mL eggplant flask, 2.46 g of the compound 5-1 obtained in Ex. 1-2, 0.37 g of the compound 13-1 obtained in Ex. 2-3, 0.23 g of 2-methyl-2-propanol, 0.08 g of a 48 mass % potassium hydroxide aqueous solution and 0.08 g of water were put, followed by stirring at 70° C. for 48 hours. The mixture was cooled to 25° C., methanol was put, followed by sufficient stirring, and AC-6000 was put, followed by sufficient stirring. The AC-6000 layer was recovered, the solvent was distilled off, and the residue was purified by silica gel column chromatography to obtain 2.55 g (yield: 91%) of compound 2-1.

Compound 1-1 can be obtained in the same manner as in Ex. 1-5 also by using the compound 2-1 obtained in Ex. 2-4.

### Ex. 3

### Ex. 3-1

Into a 50 mL eggplant flask, 15 g of the compound 6-1 obtained in the same manner as in Ex. 1-3, 0.40 g of KF and 10 mL of N,N-dimethylformamide were put, followed by stirring at 80° C. for 8 hours. The solid was removed by filtration, and the filtrate was purified by silica gel column chromatography to obtain 12.1 g (yield: 85%) of compound 8-1.

CF₃—O—(CF₂CF₂O—CF₂CF₂CF₂CF₂O)ₓ₃CF₂CF₂O—CF₂CF₂CF₂CH₂O—CF₂CHFO—CF₂CF(CF₃)O—CF₂CF₂—SO₂F formula 8-1

NMR spectrum of compound 8-1:

¹H-NMR (300.4 MHz, solvent: CDCl₃, reference: TMS) δ(ppm): 6.0 (1H), 4.5 (2H).

¹⁹F-NMR (282.7 MHz, solvent: CDCl₃, reference: CFCl₃) δ(ppm): +45 (1F), −55 (3F), −78 (2F), −79 (3F), −83 (50F), −85 (1F), −88 (50F), −90 (4F), −112 (2F), −120 (2F), −125 (48F), −126 (2F), −144 (2F).

Mean value of unit number x3: 12.

### Ex. 3-2

Into a 500 mL nickel reactor, 250 mL of ClCF₂CFClCF₂OCF₂CF₂C₁(CFE-419) was put, and nitrogen was blown in. After the oxygen concentration was sufficiently lowered, a 20% fluorine gas (diluted with nitrogen) was blown in for one hour. The exhaust gas was neutralized with an alkali. A CFE-419 solution (20 mass %, mass of compound 8-1: 12 g) of the compound 8-1 obtained in Ex. 3-1 was added over a period of 2 hours. The ratio of the fluorine introduction rate (mol/hr) to the introduction rate (mol/hr) of H atoms in the compound 8-1 was adjusted to be 2:1. After addition of the compound 8-1, a CFE-419 solution (0.1 mass %) containing 0.5 g of benzene was intermittently charged. After charging of benzene, a fluorine gas was blown in for one hour, and finally the system in the reactor was sufficiently replaced with a nitrogen gas.

The solvent was distilled off to obtain 10.5 g of compound 9-1.

CF₃—O—(CF₂CF₂O—CF₂CF₂CF₂CF₂O)ₓ₃CF₂CF₂O—CF₂CF₂CF₂CF₂O—CF₂CF₂O—CF₂CF(CF₃)O—CF₂CF₂—SO₂F formula 9-1

NMR spectrum of compound 9-1:

¹⁹F-NMR (282.7 MHz, solvent: CDCl₃, reference: CFCl₃) δ(ppm): +45 (1F), −55 (3F), −78 (2F), −79 (3F), −83 (50F), −85 (1F), −88 (50F), −90 (4F), −112 (2F), −125 (48F), −126 (2F), −144 (1F).

Mean value of unit number x3: 12.

### Ex. 3-3

Into a 50 mL eggplant flask, 6.0 g of the compound 9-1 obtained in Ex. 3-2, 7.0 mL of 1,3-di(trifluoromethyl)benzene, 0.45 g of triethylamine and 0.45 g of the compound 7-1 were put, followed by stirring overnight under reflux with heating. Methanol was put, followed by sufficient stirring, and AC-6000 was put, followed by sufficient stirring. The AC-6000 layer was recovered, the solvent was distilled off, and the residue was purified by silica gel column chromatography to obtain 5.4 g (yield: 90%) of compound 2-2.

CF₃—O—(CF₂CF₂O—CF₂CF₂CF₂CF₂O)ₓ₃CF₂CF₂O—CF₂CF₂CF₂CF₂O—CF₂CF₂O—CF₂CF(CF₃)O—CF₂CF₂—SO₂NH—CH₂—C[—CH₂—CH═CH₂]₃ formula 2-2

NMR spectrum of compound 2-2:

¹H-NMR (300.4 MHz, solvent: CDCl₃, reference: TMS) δ(ppm): 6.0 (3H), 5.0 (6H), 2.6 (2H), 1.9 (6H).

¹⁹F-NMR (282.7 MHz, solvent: CDCl₃, reference: CFCl₃) δ(ppm): −55 (3F), −78 (2F), −79 (3F), −83 (50F), −85 (1F), −88 (50F), −90 (4F), −116 (2F), −125 (48F), −126 (2F), −144 (1F).

Mean value of unit number x3: 12.

### Ex. 3-4

Into a 50 mL eggplant flask, 1 g of the compound 2-2 obtain Ex. 3-3, 0.11 g of trimethoxysilane, 0.0011 g of aniline, 1.0 g of AC-6000 and 0.0033 g of a platinum/1,3-divinyl-1,1,3,3-tetramethyldisiloxane complex were put, followed by stirring at 25° C. overnight. The mixture was concentrated to obtain 1.0 g (yield: 100%) of compound 1-2.

CF₃—O—(CF₂CF₂O—CF₂CF₂CF₂CF₂O)ₓ₃CF₂CF₂O—CF₂CF₂CF₂CF₂O—CF₂CF₂O—CF₂CF(CF₃)O—CF₂CF₂—SO₂NH—CH₂—C[—CH₂CH₂CH₂—Si(OCH₃)₃]₃ formula 1-2

NMR spectrum of compound 1-2:

¹H-NMR (300.4 MHz, solvent: CDCl₃, reference: TMS) δ(ppm): 4.0 (27H) 2.6 (2H), 1.3 (12H), 0.7 (6H).

¹⁹F-NMR (282.7 MHz, solvent: CDCl₃, reference: CFCl₃) δ(ppm): −55 (3F), −78 (2F), −79 (3F), −83 (50F), −85 (1F), −88 (50F), −90 (4F), −116 (2F), −125 (48F), −126 (2F), −144 (1F).

Mean value of unit number x3: 12, number average molecular weight of compound 1-2: 4,700.

### Ex. 4

### Ex. 4-1

Into a 100 mL eggplant flask, 4.0 g of the compound 6-1 obtained in the same manner as in Ex. 1-3, 5.0 mL of 1,3-di(trifluoromethyl)benzene and 0.18 g of compound 7-2 (manufactured by Tokyo Chemical Industry Co., Ltd., D0069) were put, followed by stirring overnight under reflux with heating. The mixture was cooled to 25° C., methanol was put, followed by sufficient stirring, and AC-6000 was put, followed by sufficient stirring. The AC-6000 layer was recovered, the solvent was distilled off, and the residue was purified by silica gel column chromatography to obtain 3.5 g (yield: 90%) of compound 2-3.

HN[—CH₂—CH═CH₂]₂ formula 7-2

CF₃—O—(CF₂CF₂O—CF₂CF₂CF₂CF₂O)ₓ₃CF₂CF₂O—CF₂CF₂CF₂CH₂O—CF₂CHFO—CF₂CF(CF₃)O—CF₂CF₂—SO₂N[—CH₂—CH═CH₂]₂ formula 2-3

NMR spectrum of compound 2-3:

¹H-NMR (300.4 MHz, solvent: CDCl₃, reference: TMS) δ(ppm): 6.0 (3H), 5.2 (4H), 4.5 (2H), 3.3 (4H).

¹⁹F-NMR (282.7 MHz, solvent: CDCl₃, reference: CFCl₃) δ(ppm): −55 (3F), −78 (2F), −79 (3F), −83 (50F), −85 (1F), −88 (50F), −90 (4F), −116 (2F), −120 (2F), −125 (48F), −126 (2F), −144 (2F).

Mean value of unit number x3: 12.

### Ex. 4-2

Into a 50 mL eggplant flask, 1.0 g of the compound 2-3 obtained in Ex. 4-1, 0.083 g of trimethoxysilane, 0.001 g of aniline, 1.0 g of AC-6000 and 0.0033 g of a platinum/1,3-divinyl-1,1,3,3-tetramethyldisiloxane complex were put, followed by stirring at 25° C. overnight. The mixture was concentrated to obtain 1.0 g (yield: 100%) of compound 1-3.

CF₃—O—(CF₂CF₂O—CF₂CF₂CF₂CF₂O)ₓ₃CF₂CF₂O—CF₂CF₂CF₂CH₂O—CF₂CHFO—CF₂CF(CF₃)O—CF₂CF₂—SO₂N[—CH₂CH₂CH₂—Si(OCH₃)₃]₂ formula 1-3

NMR spectrum of compound 1-3:

¹H-NMR (300.4 MHz, solvent: CDCl₃, reference: TMS) δ(ppm): 6.0 (1H), 4.5 (2H), 4.0 (18H), 3.3 (4H), 1.5 (4H), 0.7 (4H).

¹⁹F-NMR (282.7 MHz, solvent: CDCl₃, reference: CFCl₃) δ(ppm): −55 (3F), −78 (2F), −79 (3F), −83 (50F), −85 (1F), −88 (50F), −90 (4F), −116 (2F), −120 (2F), −125 (48F), −126 (2F), −144 (2F).

Mean value of unit number x3: 12, number average molecular weight of compound 1-3: 4,700.

### Ex. 5

### Ex. 5-1

Into a 50 mL eggplant flask, 3.0 g of the compound 9-1 obtained in the same manner as in Ex. 3-2, 3.5 mL of 1,3-di(trifluoromethyl)benzene, 0.21 g of triethylamine and 0.14 g of compound 7-2 were put, followed by stirring overnight under reflux with heating. Methanol was put, followed by sufficient stirring, and AC-6000 was put, followed by sufficient stirring. The AC-6000 layer was recovered, the solvent was distilled off, and the residue was purified by silica gel column chromatography to obtain 2.6 g (yield: 90%) of compound 2-4.

CF₃—O—(CF₂CF₂O—CF₂CF₂CF₂CF₂O)ₓ₃CF₂CF₂O—CF₂CF₂CF₂CF₂O—CF₂CF₂O—CF₂CF(CF₃)O—CF₂CF₂—SO₂N[—CH₂—CH═CH₂]₂ formula 2-4

NMR spectrum of compound 2-4:

¹H-NMR (300.4 MHz, solvent: CDCl₃, reference: TMS) δ(ppm): 6.0 (2H), 5.0 (4H), 1.9 (4H).

¹⁹F-NMR (282.7 MHz, solvent: CDCl₃, reference: CFCl₃) δ(ppm): −55 (3F), −78 (2F), −79 (3F), −83 (50F), −85 (1F), −88 (50F), −90 (4F), −116 (2F), −125 (48F), −126 (2F), −144 (1F).

Mean value of unit number x3: 12.

### Ex. 5-2

Into a 50 mL eggplant flask, 1.0 g of the compound 2-4 obtained in Ex. 5-1, 0.084 g of trimethoxysilane, 0.0010 g of aniline, 1.0 g of AC-6000 and 0.0033 g of a platinum/1,3-divinyl-1,1,3,3-tetramethyldisiloxane complex were put, followed by stirring overnight at 25° C. The mixture was concentrated to obtain 1.0 g (yield: 100%) of compound 1-4.

CF₃—O—(CF₂CF₂O—CF₂CF₂CF₂CF₂O)ₓ₃CF₂CF₂O—CF₂CF₂CF₂CF₂O—CF₂CF₂O—CF₂CF(CF₃)O—CF₂CF₂—SO₂N[—CH₂CH₂CH₂—Si(OCH₃)₃]₂ formula 1-4

NMR spectrum of compound 1-4:

¹H-NMR (300.4 MHz, solvent: CDCl₃, reference: TMS) δ(ppm): 4.0 (18H), 3.3 (4H), 1.5 (4H), 0.7 (4H).

¹⁹F-NMR (282.7 MHz, solvent: CDCl₃, reference: CFCl₃) δ(ppm): −55 (3F), −78 (2F), −79 (3F), −83 (50F), −85 (1F), −88 (50F), −90 (4F), −116 (2F), −125 (48F), −126 (2F), −144 (1F).

Mean value of unit number x3: 12, number average molecular weight of compound 1-4: 4,700.

### Ex. 6

Compound 10-1 was obtained in accordance with the method as disclosed in Ex. 3 of WO2017/038832.

CF₃—O—(CF₂CF₂O—CF₂CF₂CF₂CF₂O)ₓ₃CF₂CF₂O—CF₂CF₂CF₂—CH₂—N[—CH₂CH₂CH₂—Si(OCH₃)₃]₂ formula 10-1

### Ex. 7

Compound 10-2 was obtained in accordance with the method as disclosed in Ex. 6 of WO2013/121984.

CF₃—O—(CF₂CF₂O—CF₂CF₂CF₂CF₂O)ₓ₃CF₂CF₂O—CF₂CF₂CF₂—C(O)N H—CH₂CH₂CH₂—Si(OCH₃)₃ formula 10-2

### Ex. 8 to 13: Production and Evaluation of Article

Using the compound obtained in each of Ex. 1 and 3 to 7, a substrate was surface-treated to obtain an article in each of Ex. 8 to 13. As the surface treatment method, in each Ex., the following dry coating method and wet coating method were respectively employed. As the substrate, chemically tempered glass was used. With respect to the obtained article, evaluations were carried out by the following methods.

The results are shown in Table 1.

### (Dry Coating Method)

The dry coating was carried out by using a vacuum deposition apparatus (manufactured by ULVAC Co., VTR-350M) (vacuum deposition method). 0.5 g of the compound obtained in each of Ex. 1 and 3 to 7 was filled in a boat made of molybdenum in the vacuum deposition apparatus, and inside of the vacuum deposition apparatus was evacuated to a level of at most 1×10⁻³ Pa. The boat having the compound placed therein, was heated at a temperature raising rate of at most 10° C./min, and at the time when the vapor deposition rate by a quartz oscillator film thickness meter exceeded 1 nm/sec, the shutter was opened to initiate film deposition on the surface of a substrate. When the film thickness became about 50 nm, the shutter was closed to terminate film deposition on the surface of the substrate. The substrate on which the compound was deposited, was subjected to heat treatment at 200° C. for 30 minutes, followed by washing with AK-225 to obtain an article having a surface layer on the surface of the substrate.

### (Wet Coating Method)

The compound obtained in each of Ex. 1 and 3 to 7, and C₄F₉OC₂H₅ (manufactured by 3M, Novec (registered trademark) 7200) as a medium, were mixed to prepare a coating liquid having a solid content concentration of 0.05%. A substrate was dipped in the coating liquid and allowed to stand for 30 minutes, whereupon the substrate was taken out (dip coating method). The coating film was dried at 200° C. for 30 minutes and washed with AK-225, to obtain an article having a surface layer on the surface of the substrate.

### (Evaluation Methods)

### <Method for Measuring Contact Angle>

The contact angle of about 2 μL of distilled water or n-hexadecane placed on the surface of the surface layer, was measured by using a contact angle measuring apparatus (manufactured by Kyowa Interface Science Co., Ltd., DM-500). Measurements were conducted at five different points on the surface of the surface layer, and the average value was calculated. For the calculation of the contact angle, a 2θ method was employed.

### <Initial Contact Angle>

With respect to the surface layer, the initial water contact angle and the initial n-hexadecane contact angle were measured by the above-described measuring method. The evaluation standards are as follows.

Initial water contact angle:

⊚ (excellent): at least 115 degrees.

◯ (good): at least 110 degrees and less than 115 degrees.

Δ (acceptable): at least 100 degrees and less than 110 degrees.

X (poor): less than 100 degrees.

Initial n-hexadecane contact angle:

⊚ (excellent): at least 66 degrees.

◯ (good): at least 65 degrees and less than 66 degrees.

Δ (acceptable): at least 63 degrees and less than 65 degrees.

x (poor): less than 63 degrees.

### <Light Resistance>

To the surface layer, by means of a tabletop xenon arc lamp type accelerated light resistance testing machine (manufactured by Toyo Seiki Seisaku-sho, Ltd., SUNTEST XLS+), light (650 W/m², 300 to 700 nm) was applied at a black panel temperature of 63° C. for 1,000 hours, whereupon the water contact angle was measured. The smaller the decrease in water contact angle after the accelerated light resistance test, the smaller the decrease in performance due to light, and the better the light resistance. The evaluation standards are as follows.

⊚ (excellent): The change in water contact angle after the accelerated light resistance test is at most 2 degrees.

◯ (good): The change in water contact angle after the accelerated light resistance test is more than 2 degrees and at most 5 degrees.

Δ (acceptable): The change in water contact angle after the accelerated light resistance test is more than 5 degrees and at most 10 degrees.

x (poor): The change in water contact angle after the accelerated light resistance test is more than 10 degrees.

### <Abrasion Resistance (Steel Wool)>

With respect to the surface layer, in accordance with JIS L0849: 2013 (ISO 105-X12: 2001), using a reciprocating traverse testing machine (manufactured by KNT Co.), steel wool Bon Star (#0000) was reciprocated 10,000 times under a pressure of 98.07 kPa at a speed of 320 cm/min, whereupon the water contact angle was measured. The smaller the decrease in water repellency (water contact angle) after the friction, the smaller the decrease in performance due to friction, and the better the abrasion resistance. The evaluation standards are as follows.

⊚ (excellent): The change in water contact angle after reciprocation of 10,000 times is at most 2 degrees.

◯ (good): The change in water contact angle after reciprocation of 10,000 times is more than 2 degrees and at most 5 degrees.

Δ (acceptable): The change in water contact angle after reciprocation of 10,000 times is more than 5 degrees and at most 10 degrees.

x (poor): The change in water contact angle after reciprocation of 10,000 times is more than 10 degrees.

### <Chemical Resistance (Alkali Resistance)>

The article was immersed in a 1N aqueous sodium hydroxide solution (pH: 14) for 5 hours, then washed with water and air-dried, whereupon the water contact angle was measured. The smaller the decrease in water contact angle after the test, the smaller the decrease in performance due to alkali, and the better the alkali resistance. The evaluation standards are as follows.

⊚ (excellent): The change in water contact angle after the alkali resistance test is at most 2 degrees.

◯ (good): The change in water contact angle after the alkali resistance test is more than 2 degrees and at most 5 degrees.

Δ (acceptable): The change in water contact angle after the alkali resistance test is more than 5 degrees and at most 10 degrees.

x (poor): The change in water contact angle after the alkali resistance test is more than 10 degrees.

### <Chemical Resistance (Salt Water Resistance)>

The salt spray test was carried out in accordance with JIS H8502. That is, the article was exposed to salt atmosphere in a salt spray tester (manufactured by Suga Test Instruments Co., Ltd.) for 300 hours, and then, the water contact angle was measured. The smaller the decrease in water contact angle after the test, the smaller the decrease in performance due to salt water, and the better the salt water resistance. The evaluation standards are as follows.

⊚ (excellent): The change in water contact angle after the salt spray test is at most 2 degrees.

◯ (good): The change in water contact angle after the salt spray test is more than 2 degrees and at most 5 degrees.

Δ (acceptable): The change in water contact angle after the salt spray test is more than 5 degrees and at most 10 degrees.

x (poor): The change in water contact angle after the salt spray test is more than 10 degrees.

### <Fingerprint Stain Removability>

An artificial fingerprint liquid (liquid consisting of oleic acid and squalene) was deposited on a flat surface of a silicon rubber plug, and then, extra oil was wiped off by a nonwoven fabric (manufactured by Asahi Kasei Corporation, BEMCOT (registered trademark) M-3), to prepare a stamp for fingerprint. The fingerprint stamp was placed on the surface layer and pressed under a load of 9.8 N for 10 seconds. The haze at a portion having a fingerprint put, was measured by a haze meter and taken as an initial value. With respect to the portion having a fingerprint put, using a reciprocating traverse testing machine (manufactured by KNT Co.) having tissue paper attached, wiping was carried out under a load of 4.9 N. The value of haze was measured every one reciprocation for wiping, and the number of wiping times until the haze became at most 10% of the initial value, was measured. The smaller the number of wiping times, the easier the removal of fingerprint stain, and the better the fingerprint stain removability. The evaluation standards are as follows.

⊚ (excellent): The number of wiping times is at most 3 times.

◯ (good): The number of wiping times is from 4 to 5 times.

Δ (acceptable): The number of wiping times is from 6 to 8 times.

x (poor): The number of wiping times is at least 9 times.

TABLE 1

| | | | Ex. | | | | | |
|---|---|---|---|---|---|---|---|---|
| | | | 8 | 9 | 10 | 11 | 12 | 13 |
| | | | Fluorinated ether compound | | | | | |
| | | | Compound | Compound | Compound | Compound | Compound | Compound |
| | | | 1-1 | 1-2 | 1-3 | 1-4 | 10-1 | 10-2 |
| Dry coating | Initial contact | Water | ⊚ | ⊚ | ⊚ | ⊚ | ⊚ | ⊚ |
| method | angle | n-Hexadecane | ⊚ | ⊚ | ⊚ | ⊚ | ⊚ | ⊚ |
| | Light resistance | | ◯ | ◯ | ◯ | ◯ | X | Δ |
| | Abrasion resistance | | ◯ | ⊚ | ◯ | ⊚ | Δ | X |
| Wet coating | Initial contact | Water | ⊚ | ⊚ | ⊚ | ⊚ | ⊚ | ⊚ |
| method | angle | n-Hexadecane | ⊚ | ⊚ | ⊚ | ⊚ | ⊚ | ⊚ |
| | Light resistance | | ◯ | ◯ | ◯ | ◯ | X | Δ |
| | Abrasion resistance | | ◯ | ⊚ | ◯ | ⊚ | Δ | X |
| | Chemical resistance | Alkali resistance | ◯ | ◯ | ◯ | ◯ | X | X |
| | | Salt water resistance | ⊚ | ⊚ | ⊚ | ⊚ | ◯ | ◯ |

| | | | | | | |
|---|---|---|---|---|---|---|
| Fingerprint stain removability | ⊚ | ⊚ | ⊚ | ⊚ | ⊚ | ⊚ |

It was confirmed that in Ex. 8 to 11 in which the compound 1 was used, the initial water/oil repellency, abrasion resistance, fingerprint stain removability, light resistance and chemical resistance were excellent.

In Ex. 12 and 13 in which conventional fluorinated ether compounds were used, abrasion resistance, light resistance and chemical resistance were inferior.

### INDUSTRIAL APPLICABILITY

The fluorinated ether compound of the present invention is useful for various applications for which it is required to impart lubricity and water/oil repellency. For example, it may be used for a display input device such as a touch panel, surface protective coating on a transparent glass or transparent plastic member, kitchen antifouling coating, water repellent moistureproof coating or antifouling coating on electronic device, a heat exchanger or a battery, toiletry antifouling coating, coating on a member which requires liquid repellency while conducting electricity, water repellent/waterproof/water sliding coating on a heat exchanger, or a surface low friction coating on the inside of a vibrating strainer or a cylinder, etc. More specific examples of application include a front protective plate, an antireflection plate, a polarizing plate, an antiglare plate or a surface thereof having an antireflection film, of a display, an apparatus having a display input device of which the screen is operated by human fingers or hands, such as a touch panel sheet or a touch panel display of an apparatus such as a mobile phone or a personal digital assistant, a decorative building material for restroom, bathroom, lavatory, kitchen and the like, waterproof coating for a wiring board, water repellent/waterproof coating on a heat exchanger, water repellent coating on a solar cell, waterproof/water repellent coating on a printed wiring board, waterproof/water repellent coating for an electronic equipment casing or an electronic member, insulating property-improving coating on a power transmission line, waterproof/water repellent coating on a filter, waterproof coating on an electromagnetic wave absorption material or an acoustic material, antifouling coating for bathroom, kitchen instrument and toiletry, water repellent/waterproof/water sliding coating on a heat exchanger, surface low-friction coating on the inside of a vibrating strainer or a cylinder, surface protective coating on a machine component, a vacuum apparatus component, a bearing component, an automobile component, an industrial tool, etc.

This application is a continuation of PCT Application No. PCT/JP2018/030221, filed on Aug. 13, 2018, which is based upon and claims the benefit of priority from Japanese Patent Application No. 2017-159697 filed on Aug. 22, 2017. The contents of those applications are incorporated herein by reference in their entireties.

What is claimed is:

1. A fluorinated ether compound, which is a compound represented by the following formula 1: 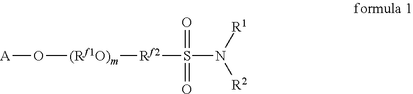
wherein A is a C₁₋₂₀ perfluoroalkyl group,
R^{f1} is a fluoroalkylene group,
m is an integer of from 2 to 500,
(R^{f1}O)ₘ may consist of two or more types of R^{f1}O differing in the number of carbon atoms,
R^{f2} is a fluoroalkylene group,
R¹ is a monovalent organic group having at least one hydrolyzable silyl group,
R² is a hydrogen atom, a monovalent organic group (excluding one having a hydrolyzable silyl group) or a monovalent organic group having at least one hydrolyzable silyl group, and
the total number of the hydrolyzable silyl group(s) in R¹ and the hydrolyzable silyl group(s) in R² is at least 2.

2. The fluorinated ether compound according to claim 1, wherein the monovalent organic group having at least one hydrolyzable silyl group is a group represented by the following formula g1:
-Q¹[-SiR³ₙL₃₋ₙ]ₚ formula g1
wherein Q¹ is a (p+1) valent organic group (excluding one having a hydrolyzable silyl group),
R³ is a hydrogen atom or a monovalent hydrocarbon group,
L is a hydrolyzable group,
n is an integer of from 0 to 2,
p is an integer of at least 1, and
when p is at least 2, the p [—SiR³ₙL₃₋ₙ] may be the same or different.

3. The fluorinated ether compound according to claim 2, wherein the group represented by the formula g1 is a group represented by the following formula g2 or g3: 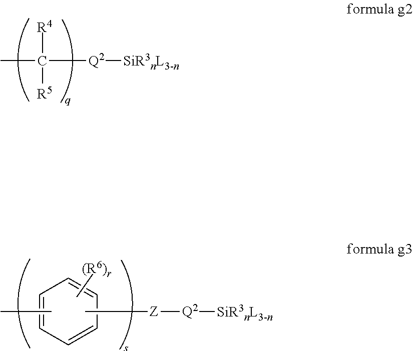
wherein R⁴ and R⁵ are each independently a hydrogen atom, a C₁₋₆ monovalent organic group (excluding one having a hydrolyzable silyl group) or -Q²-SiR³ₙL₃₋ₙ,
q is an integer of from 0 to 10,
when q is at least 2, the q (CR⁴R⁵) may be the same or different,
R⁶ is a C₁₋₆ monovalent organic group (excluding one having a hydrolyzable silyl group) or —Z-Q²-SiR³ₙL₃₋ₙ,
r is an integer of from 0 to 4,
when r is at least 2, the r R⁶ may be the same or different,
s is 1 or 2,
when s is 2, the two (φ(R⁶)ᵣ) (wherein φ is a benzene ring) may be the same or different,
Z is a single bond, —C(O)N(R⁷)— or —C(O)O—,
R⁷ is a hydrogen atom or an alkyl group,
Q² is a C₂₋₁₀ alkylene group,
R³ is a hydrogen atom or a monovalent hydrocarbon group,
L is a hydrolyzable group,
n is an integer of from 0 to 2, and
the plurality of -Q²-SiR³ₙL₃₋ₙ may be the same or different.

4. The fluorinated ether compound according to claim 2, wherein both R¹ and R² are the group represented by the formula g1 wherein p is an integer of from 1 to 3.

5. The fluorinated ether compound according to claim 2, wherein R¹ is the group represented by the formula g1 wherein p is 2 or 3, and
R² is a hydrogen atom or a monovalent organic group (excluding one having a hydrolyzable silyl group).

6. A fluorinated ether composition comprising at least one type of the fluorinated ether compound as defined in claim 1, and other fluorinated ether compound.

7. A coating liquid comprising the fluorinated ether compound as defined in claim 1, and a liquid medium.

8. An article comprising a substrate and a surface layer formed of the fluorinated ether compound as defined in claim 1 on a surface of the substrate.

9. The article according to claim 8, which has the surface layer on a surface of a member constituting a plane to be touched with fingers of a touch panel.

10. A method for producing an article, which comprises treating a surface of a substrate by dry coating method using the fluorinated ether compound as defined in claim 1 to form a surface layer formed of the fluorinated ether compound on the surface of the substrate.

11. A method for producing an article, which comprises applying the coating liquid as defined in claim 7 to a surface of a substrate by wet coating method, followed by drying to form a surface layer formed of the fluorinated ether compound on the surface of the substrate.

12. A fluorinated ether compound, which is a compound represented by the following formula 2: 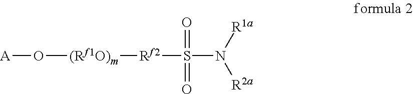
wherein A is a C₁₋₂₀ perfluoroalkyl group,
R^{f1} is a fluoroalkylene group,
m is an integer of from 2 to 500,
(R^{f1}O)ₘ may consist of two or more types of R^{f1}O differing in the number of carbon atoms,
R^{f2} is a fluoroalkylene group,
R^{1a} is a monovalent organic group having at least one ω-alkenyl group (excluding one having a hydrolyzable silyl group),
R^{2a} is a hydrogen atom, a monovalent organic group (excluding one having an ω-alkenyl group and one having a hydrolyzable silyl group) or a monovalent organic group having at least one ω-alkenyl group (excluding one having a hydrolyzable silyl group), and
the total number of the ω-alkenyl group(s) in R^{1a} and the ω-alkenyl group(s) in R^{2a} is at least 2.

13. The fluorinated ether compound according to claim 12, wherein the monovalent organic group having at least one ω-alkenyl group is a group represented by the following formula g4:
-Q^{1a}[—CH═CH₂]ₚ formula g4
wherein Q^{1a} is a single bond (only when p is 1) or a (p+1) valent organic group (excluding one having a hydrolyzable silyl group), and
p is an integer of at least 1.

14. The fluorinated ether compound according to claim 13, wherein the group represented by the formula g4 is a group represented by the following formula g5 or g6: 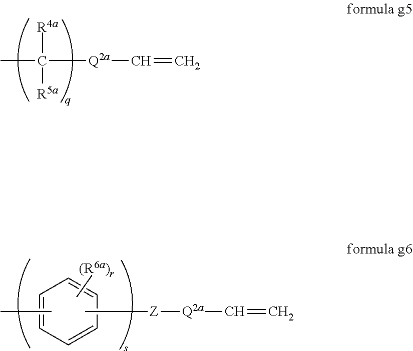
wherein R^{4a} and R^{5a} are each independently a hydrogen atom, a C₁₋₆ monovalent organic group (excluding one having a hydrolyzable silyl group) or -Q^{2a}-CH═CH₂,
q is an integer of from 0 to 10,
when q is at least 2, the q (CR^{4a}R^{5a}) may be the same or different,
R^{6a} is a C₁₋₆ monovalent organic group (excluding one having a hydrolyzable silyl group) or —Z-Q^{2a}-CH═CH₂,
r is an integer of from 0 to 4,
when r is at least 2, the r R^{6a} may be the same or different,
s is 1 or 2,
when s is 2, the two (φ(R^{6a})ᵣ) (wherein φ is a benzene ring) may be the same or different,
Z is a single bond, —C(O)N(R⁷)— or —C(O)O—,
R⁷ is a hydrogen atom or an alkyl group,
Q^{2a} is a single bond or a C₁₋₈ alkylene group, and
the plurality of Q^{2a} may be the same or different.

15. The fluorinated ether compound according to claim 13, wherein both R^{1a} and R^{2a} are the group represented by the formula g4 wherein p is an integer of from 1 to 3.

16. The fluorinated ether compound according to claim 13, wherein R^{1a} is the group represented by the formula g4 wherein p is 2 or 3, and R^{2a} is a hydrogen atom or a monovalent organic group (excluding one having an ω-alkenyl group and one having a hydrolyzable silyl group).
